(19) United States
(12) Patent Application Publication
(10) Pub. No.: US 2006/0055683 A1
(43) Pub. Date: Mar. 16, 2006

(54) Personal digital assistant device with stylus

(75) Inventor: Johan Agnes Emile Wouters, Leuven (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/521,710

(22) PCT Filed: Jul. 4, 2003
(86) PCT No.: PCT/IB03/03042

§ 371 Date: Jan. 19, 2005

(30) Foreign Application Priority Data
Jul. 24, 2002 (EP) 020780151

(51) Int. Cl. G09G 5/00

(52) U.S. Cl. 345/179; 345/905

(57) ABSTRACT

A portable stylus information input processing apparatus (1) with a removable stylus (2) and a stylus housing (9), a user-interface (UI) (3), said apparatus comprising a computer program for running a user-interactive application on or via the apparatus, or a means for inputting such a computer program, interaction taking place by contact between the stylus and the user interface (UI), characterized in that the apparatus comprises means for generating a release signal (6) generated by a program run on or via the apparatus to release the stylus, the stylus housing comprising a receiver for receiving said release signal and a release mechanism (7) for releasing the stylus in response to the release signal.

### FIELD OF THE INVENTION

The invention relates to a portable stylus information input processing apparatus, with a removable stylus and a stylus housing and a user interface (UI), said apparatus comprising a computer program for running a user interactive application on or via the apparatus, or a means for inputting such a computer program, interaction taking place by contact between the stylus and the user interface (UI).

### BACKGROUND OF THE INVENTION

A portable stylus information input processing apparatus is a computer or communication device which is small and light enough to be carried by a person. It is so small that a full-alphabet keyboard would have keys so small as to be of little use. Accordingly, the stylus information input processing apparatus includes a removable stylus. The user presses the stylus onto a User Interface (UI), e.g. comprising a touch screen. In this manner, interaction takes place between the user and the stylus information input processing apparatus, by which interaction a user interactive application can be controlled by the user or data can be supplied to said application. To this end, the stylus information input processing apparatus comprises a program, or means to input a program for running an interactive application on or via the stylus information input processing apparatus. The UI is sensitive to contact between the stylus and the UI, e.g. pressure-sensitive to the touch of the stylus, so that the user may enter data to interact. The UI is also a monitor, and thus can display data as well. Within the framework of the invention, a stylus input information processing apparatus is to be understood to include a wide range of devices, PDAs (Personal Digital Assistant) and also handheld devices such as pocket PCs, smart remotes, organisers, MP3 players, multi-media handheld devices, etc., provided that the portable apparatus or device comprises a User Interface (UI) with which the stylus can be brought into contact to input data into the device to interact with an application run on or via the device and a program for running a user interactive application on or via the PDA or means to input such a program. The stylus, when not in use, is housed in a stylus housing. The stylus may be removed and inserted into the housing. To this end, some portable stylus information input processing apparatuses currently on the market have a housing with lock and release systems, some with a spring mechanism.

Portable stylus information input processing apparatuses are known in which insertion/removal of the stylus activates an on/off switch of the apparatus so that, when the stylus is removed from the housing, the apparatus is activated or when it is put back into the housing, the apparatus is deactivated.

However, there is little or no interaction between the application running on or via the apparatus and retrieval of the stylus. There is little or no flexibility in this respect.

### OBJECT AND SUMMARY OF THE INVENTION

It is an object of the invention to increase the possibilities and flexibility of the apparatus in respect of interaction with the user.

To this end, the apparatus comprises means for generating a release signal generated by a program run on or via the apparatus to release the stylus, the stylus housing comprising a receiver for receiving said release signal and a release mechanism for releasing the stylus in response to the release signal.

In the known apparatus, there is no logical link between the program or application running on the apparatus and stylus releasing mechanism.

The stylus storing/release mechanism is totally separated from the parts of the apparatus that give added value to the user (micro-controller, application buttons, SW, screen, touch screen, speaker, . . . ). These parts will also be referred to as the heart of the apparatus. In a device in accordance with the invention, the apparatus comprises means for generating a release signal generated by a program run on or via the apparatus to release the stylus, the stylus housing comprising a receiver for receiving said release signal and a release mechanism for releasing the stylus in response to the release signal.

In the apparatus in accordance with the invention, there is a logical link between the application running on or via the apparatus and the release mechanism. Linking the stylus release mechanism to the application running on or via the apparatus gives an added value to the user by offering him the possibility to take/launch the stylus on his own request (in a first embodiment), or by having the application running on the apparatus decide that the user needs a stylus and have the stylus launched automatically (in a second embodiment). The advantage of having an application running on or via the apparatus deciding that the user needs the stylus is that the stylus is used only when it is necessary or advisable, reducing wear on the UI and reducing the risk that the stylus is lost.

Within the concept of the invention a ‘means for generating’ is to be broadly understood and comprise e.g. any piece of hardware, any circuit or sub-circuit designed for performing a conversion, imposition, rendition as described as well as any piece of software (computer program or sub-program or set of computer programs, or program code(s)) designed or programmed to perform a generation in accordance with the invention as well as any combination of pieces of hardware and software acting as such, alone or in combination, without being restricted to the embodiments given below by way of example. The apparatus may itself hold programs with which an application may be run (in which case the application is run on the apparatus), or the apparatus may provide a link between the user and an application which is itself run on a different device, e.g. via the internet, in which case the application is run via the apparatus.

The invention is also embodied in any computer program comprising program code means for use in an apparatus in accordance with the invention as well as in any computer program product comprising program code means stored on a computer readable medium for use in an apparatus in accordance with the invention.

These and other aspects of the invention are apparent from and will be elucidated with reference to the embodiments described hereinafter.

### BRIEF DESCRIPTION OF THE DRAWINGS

In the drawings:

FIG. 1 illustrates a portable stylus information input processing apparatus, in this case a PDA.

FIG. 2 schematically illustrates a portable stylus information input processing apparatus, in this example a PDA, in accordance with the invention

FIGS. 3A and 3B illustrate a PDA on which a program is running with different levels

FIG. 4 illustrates a PDA showing on the User Interface a soft button by which means release of the stylus may be initiated.

The figures are not drawn to scale. Generally, identical components are denoted by the same reference numerals in the figures.

### DETAILED DESCRIPTION OF PREFERRED EMBODIMENTS

FIG. 1 shows a portable stylus information input processing apparatus, in this case a PDA 1 having a stylus 2 and a user interface 3. Portable stylus information input processing apparatuses such as compact handheld devices commonly referred to as PDA (Personal Digital Assistant) devices or handheld computers (which within the framework of the invention are also denoted PDAs) have a pen-like stylus to actuate menu items shown on a display screen of the device by touching an icon appearing on the screen. Within the framework of the invention, a portable stylus information input processing apparatus is to be understood to include any stylus input information processing apparatus or device, including PDAs and handheld devices such as pocket PCs, smart remotes, organisers, MP3 players, multi-media handheld devices, etc., provided that the apparatus or device comprises a User Interface (UI) with which the stylus can make contact to input data into the apparatus to interact with an application run on or via the apparatus and a program for running a user-interactive application on or via the apparatus or means to input such a program. An application run on or via the apparatus includes applications that are loaded into the apparatus itself as well as applications which are run on another device but for which the apparatus forms a communication means (link) with the application. The latter may be, for instance, the case when a link is made via the apparatus with a site on the internet having an application. The stylus may also be used for inputting information to the device by writing or drawing on the display screen directly. In both cases, the user interacts with the application running on or via the apparatus. In the examples given below, a PDA is shown as an example of a portable stylus information input processing apparatus. The invention, however, as well as all features are not restricted to a PDA, unless specifically stated.

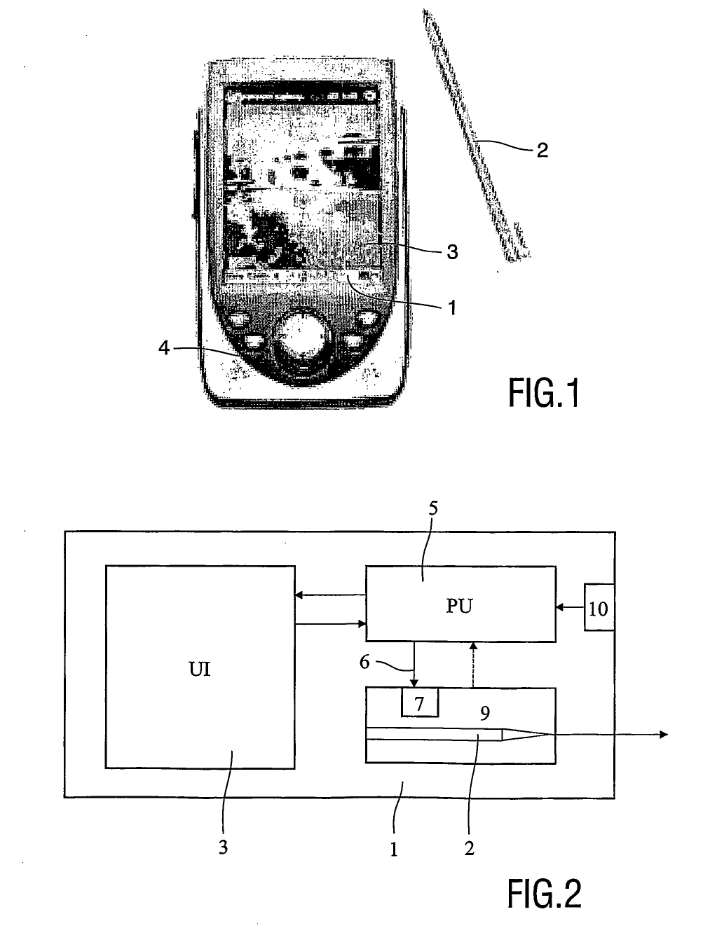

FIG. 2 schematically shows a PDA in accordance with the invention.

The PDA comprises a User Interface (UI) 3, a stylus 2 in a stylus housing 9. The stylus housing comprises a release mechanism 7 for the stylus. In embodiments, the mechanism may also be used to lock the stylus in the housing, in which cases the mechanism is a lock/release mechanism. Furthermore, there is a processing unit PU 5 loaded with a program or into which a program can be loaded. In the latter case, the PDA comprises a means (an interface 10) via which a program can be loaded into the processing unit. Within the framework of the invention, the manner by which means a program is loaded is not restricted to any particular method or the means associated with such method. The programs (or parts of programs, or program codes) may be installed in the factory, downloaded via the internet, via a telephone line, or by any other method or means.

The processing unit and the release mechanism are coupled, i.e. the PDA has means for providing a release signal 6 generated by an application run on or via the PDA to the lock/release mechanism 7.

Thus, there is provided a logical link between the application run on or via the PDA and the release of the stylus.

Linking of the stylus storing/launching part to the heart of the PDA can be done in various ways. Below is a limited list of possible solutions (again this list is only provided for clarification and should not be considered to be restrictive) within embodiments of the PDA in accordance with the invention:
The stylus releasing mechanism part can be or may comprise:
   A mechanical spring system that provides a lock mechanism to prevent the stylus from falling out.
   An electromechanical system including a motor linked to a mechanical construction holding the stylus.
   A magnetic system keeping the stylus in position when stored. When reverse polarised, the stylus will be pushed away.
   A “muscle wire” that is deforming (getting shorter and longer) by heating/cooling the wire (by means of electric current).
Possible stylus lock mechanisms can be:
   A pin preventing the stylus from jumping/falling out
   A magnetic lock
   A cover on top of the stylus
   A motor linked to a mechanical construction holding the stylus position
The link between the stylus releasing mechanism and the heart of the PDA providing the logical link between an application run on the PDA will generally be an electrical connection. However, other means are possible, such as wireless connections, such as IR connections, radio frequency connections, etc.

Some examples of devices in accordance with the invention are given below.

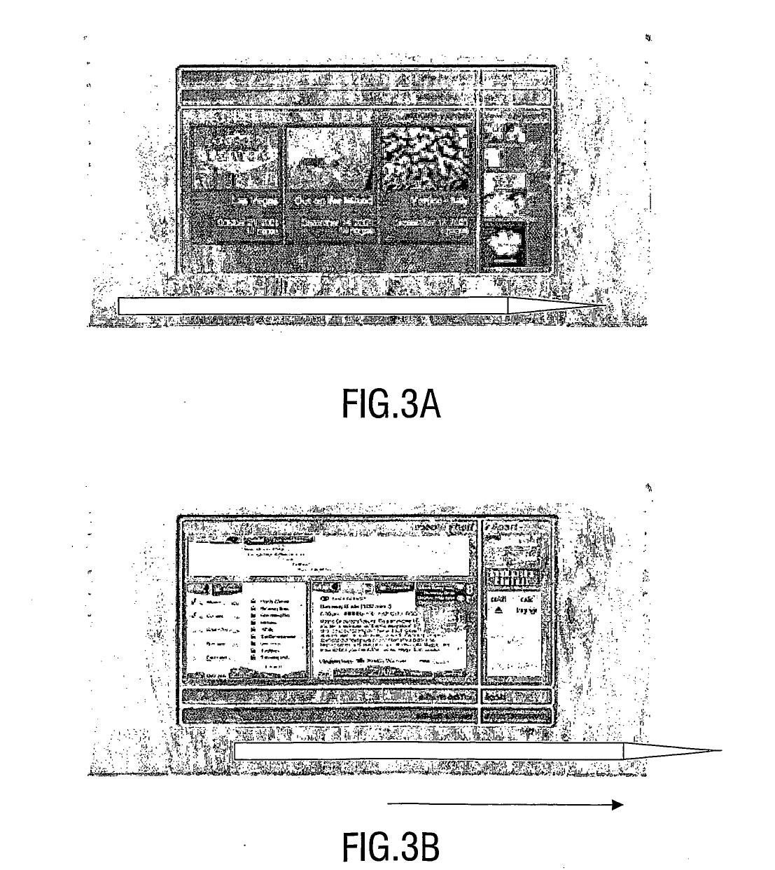

A first example is shown in FIGS. 3A and 3B, showing a PDA on which an application is run, the PDA having a touch screen LCD device with a UI that provides different levels of control precision. The lower levels (FIG. 3A) provide relatively large icons allowing finger control precision. In such levels, all the control areas are big enough to control with a tip of a finger.

By touching specific icons or parts on the UI, the application enters a higher or deeper level and the screen will change to a finer grid version (see FIG. 3B) where control needs to be or is better done using a stylus because a finger is too big for the soft buttons. The program has a program code which, upon occurrence of a certain event, e.g. a transition from the lower ‘finger’-coarse level to the finer level generates a release signal 6 (see FIG. 2) which releases the stylus from the stylus housing, by activating the release mechanism 7. In this preferred embodiment, the event is the transition of one level to another level. Although this is a preferred embodiment within the framework of the invention, different events may trigger an embodiment stylus release. For instance:
initiation of an application (the stylus is immediately released when a certain application is initiated). An example of this could be, for instance, when contact is made via the PDA contact with a site on the internet having a certain application, for which use of the stylus is recommendable.
transition within an application from one level to another (the example given above)
in case a chain or number of events indicates that use of a stylus is recommendable, which may e.g. be the case when several icons are touched substantially simultaneously, which indicates that, for this particular user, the use of a finger no longer suffices, and that use of the stylus is recommendable.
Sometimes the user does not use the stylus but some other pointed object (a pencil for instance, which he had in his/her hands). However, use of such “pens” may harm the device. The form and shape of the contact area or the pressure distribution on the UI may form an indication of the use of such “pens”. The program may comprise a program code, which, in such an event, causes a release of the stylus.

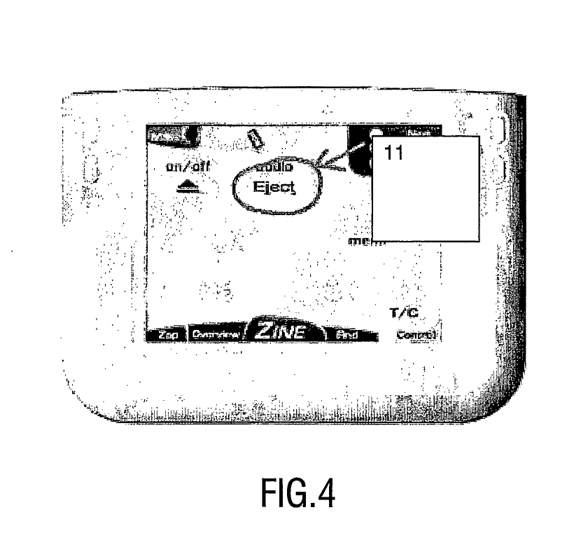

In another embodiment, the application generates a soft button (see FIG. 4) on the U, the user can then touch the soft button, whereupon the stylus is released. The advantage is, inter alia a.o. that the user can release the stylus at will while keeping his eyes on the user interface. Conventional hand-operated stylus launch systems necessitate turning upside down of the PDA. The use of a soft button is more user-friendly.

In applications, both embodiments may be combined, i.e. applications are run which provide for a soft button, to enable a user to release the stylus at will, and also releasing the stylus at the occurrence of an event, such as e.g. transition from one level to a finer level.

It will be appreciated by persons skilled in the art that the present invention is not limited by what has been particularly shown and described hereinbefore. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The present invention has been described in terms of specific embodiments, which are illustrative of the invention and should not be construed as limiting. The invention may be implemented in hardware, firmware or software, or in a combination of them. Other embodiments are within the scope of the following claims. For instance, in the given embodiments a touch stylus is described and the UI is pressure sensitive to the stylus. In embodiments, however, the UI may be light-sensitive and the stylus may comprise a small light in the tip of the stylus. It is also possible that electrical contact is made between the stylus and the UI for inputting data.

1. A portable stylus information input processing apparatus (1) with a removable stylus (2) and a stylus housing (9), a user interface (UI) (3), said apparatus comprising a computer program for running a user-interactive application on or via the apparatus, or a means for inputting such a computer program, interaction taking place by contact between the stylus and the user interface (UI), characterized in that the apparatus comprises means for generating a release signal (6) generated by a program run on or via the apparatus to release the stylus, the stylus housing comprising a receiver for receiving said release signal and a release mechanism (7) for releasing the stylus in response to the release signal (6).

2. An apparatus as claimed in claim 1, characterized in that the apparatus comprises a program for running an application on or via the apparatus, wherein in operation occurrence of an event triggers the release of the stylus.

3. An apparatus as claimed in claim 1, characterized in that the event triggering release of the stylus is formed by a transition between a first level and a second level of an application.

4. An apparatus as claimed in claim 1, characterized in that the apparatus comprises a program comprising a program code for displaying a soft button (11) on the User Interface, while touching said button generates a release signal.

5. A computer program comprising program code means for use in a device as claimed in claim 1.

6. A computer program product comprising program code means stored on a computer readable medium for use in a device as claimed in claim 1.
